(19) United States
(12) Patent Application Publication
(10) Pub. No.: US 2024/0203446 A1
(43) Pub. Date: Jun. 20, 2024

(54) METHOD OF OPERATING SOUND RECOGNITION DEVICE IDENTIFYING SPEAKER AND ELECTRONIC DEVICE HAVING THE SAME

(71) Applicant: Electronics and Telecommunications Research Institute, Daejeon (KR)

(72) Inventors: Kyoung Ju NOH, Daejeon (KR); Jeong Muk LIM, Daejeon (KR); SEUNG EUN CHUNG, Daejeon (KR); Hyun Tae JEONG, Daejeon (KR)

(73) Assignee: Electronics and Telecommunications Research Institute, Daejeon (KR)

(21) Appl. No.: 18/493,547

(22) Filed: Oct. 24, 2023

(30) Foreign Application Priority Data
Dec. 16, 2022 (KR) 10-2022-0176673

(51) Int. Cl. G10L 25/63; G10L 17/02; G10L 25/84

(52) U.S. Cl. CPC G10L 25/63; G10L 17/02; G10L 25/84

(57) ABSTRACT

Disclosed is a method of operating a sound recognition device communicating with a sound sensor that recognizes an utterance sound of a first speaker to generate a sound signal, which includes receiving the sound signal from the sound sensor, dividing the sound signal into a plurality of segments, determining whether each of the plurality of segments is a voice segment or a non-voice segment, generating first emotion recognition information of the first speaker based on a first segment determined to be the voice segment among the plurality of segments, and identifying the first speaker by fusing the first segment and the first emotion recognition information.

### CROSS-REFERENCE TO RELATED APPLICATIONS

This application claims priority under 35 U.S.C. § 119 to Korean Patent Application No. 10-2022-0176673 filed on Dec. 16, 2022, in the Korean Intellectual Property Office, the disclosures of which are incorporated by reference herein in their entireties.

### BACKGROUND

Embodiments of the present disclosure described herein relate to a sound recognition device, and more particularly, relate to a method of operating a sound recognition device for identifying a speaker, and an electronic device including the same.

Sound sensors may collect sound. The sound sensors may produce a sound signal that includes an utterance sound and an ambient sound. Sound-based services may extract various information from sound signals and may provide them to users.

Voice-based services may recognize a user's simple command or may identify a speaker. However, in the voice-based services, the utterance sound should be dominantly louder than the ambient sound, and a user should be in close proximity to the sound sensor.

The ambient sound-based services may recognize a user's ambient situation and may provide information about the user's ambient situation. For example, the ambient sound-based services may recognize a user's dangerous situation and may notify the user of the dangerous situation. However, the ambient sound-based services cannot recognize the user's emotional state or identify the user.

Further, when the voice-based service identifies a speaker, when the speaker's emotional state is not calm, it is difficult to identify the speaker compared to when the speaker's emotional state is calm. For example, in the case of voices having a high arousal or a high valence, the speaker identification of the voice-based service is degraded.

### SUMMARY

Embodiments of the present disclosure provide a method of operating a sound recognition device for identifying a speaker and an electronic device including the same.

According to an embodiment of the present disclosure, a sound recognition device communicates with a sound sensor that recognizes an utterance sound of a first speaker to generate a sound signal. A method of operating the sound recognition device includes receiving the sound signal from the sound sensor, dividing the sound signal into a plurality of segments, determining whether each of the plurality of segments is a voice segment or a non-voice segment, generating first emotion recognition information of the first speaker based on a first segment determined to be the voice segment among the plurality of segments, and identifying the first speaker by fusing the first segment and the first emotion recognition information.

According to an embodiment, the sound sensor may further recognize an utterance sound of a second speaker different from the first speaker to generate the sound signal. The method may further include generating second emotion recognition information of the second speaker based on a second segment determined to be the voice segment among the plurality of segments, and identifying the second speaker by fusing the second segment and the second emotion recognition information.

According to an embodiment, the sound sensor may further recognize a non-utterance sound of the first speaker to generate the sound signal. The method may further include generating first situation recognition information based on a third segment determined to be the non-voice segment among the plurality of segments.

According to an embodiment, the sound sensor may further recognize an ambient sound to generate the sound signal. The method may further include generating second situation recognition information based on a fourth segment determined to be the non-voice segment among the plurality of segments.

According to an embodiment, the second situation recognition information may indicate one of a scene sound, an animal sound, a surrounding object sound, a music sound, and a natural sound.

According to an embodiment, the dividing of the sound signal into the plurality of segments may include dividing the sound signal into a plurality of frames of a reference time unit, generating situation information of each of the plurality of frames, and generating the plurality of segments by grouping a series of frames having the same situation information among the plurality of frames.

According to an embodiment, the generating of the first emotion recognition information of the first speaker based on the first segment determined to be the voice segment among the plurality of segments may include generating a SER (Speech Emotion Recognition) embedding vector based on the first segment, and generating the first emotion recognition information based on the SER embedding vector.

According to an embodiment, the identifying of the first speaker by fusing the first segment and the first emotion recognition information may include generating a SI (Speaker Identification) embedding vector based on the first segment and the SER embedding vector, and identifying the first speaker based on the SI embedding vector.

According to an embodiment, the method may further include extracting a frequency domain feature and a time domain feature of the first segment, and the frequency domain feature may include an MFCC (Mel-frequency cepstral coefficient) value, and the time domain feature may include at least one of the loudness, speed, stress, pitch change, speech time, and pause time of the utterance sound.

According to an embodiment of the present disclosure, an electronic device includes a sound sensor that recognizes an utterance sound of a first speaker to generate a sound signal, and a sound recognition device that divides the sound signal into a plurality of segments, determines whether each of the plurality of segments is a voice segment or a non-voice segment, generates first emotion recognition information of the first speaker based on a first segment determined to be the voice segment, and fuses the first segment and the first emotion recognition information to identify the first speaker.

According to an embodiment, the sound recognition device may include a segment manager that receives the sound signal, divides the sound signal into a plurality of segments, and determines whether each of the plurality of segments is a voice segment or a non-voice segment, an emotion information recognition device that receives the first segment determined to be the voice segment and generates the first emotion recognition information of the first speaker based on the first segment, and a speaker identification device that receives the first segment and the first emotion recognition information and fuses the first segment and the first emotion recognition information to identify the first speaker.

According to an embodiment, the sound sensor may further recognize an utterance sound of a second speaker different from the first speaker and a non-utterance sound of the first speaker to generate the sound signal, and the emotion information recognition device may generate second emotion recognition information of the second speaker based on a second segment determined to be the voice segment, and the sound recognition device may further include a situation information recognition device that generates first situation recognition information based on a third segment determined to be the non-voice segment.

According to an embodiment, the sound sensor may further recognize an ambient sound to generate the sound signal, and the situation information recognition device may further generate second situation recognition information based on a fourth segment determined to be the non-voice segment.

According to an embodiment, the emotion information recognition device may further generate a SER (Speech Emotion Recognition) embedding vector based on the first segment and generate the first emotion recognition information based on the SER embedding vector, and the speaker identification device may further generate a SI (Speaker Identification) embedding vector based on the first segment and the SER embedding vector and may identify the first speaker based on the SI embedding vector.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an electronic device according to an embodiment of the present disclosure.

FIG. 2 is a block diagram embodying a sound recognition device of FIG. 1, according to some embodiments of the present disclosure.

FIG. 3 is a table illustrating situation recognition information, emotion recognition information, and speaker identification information, according to some embodiments of the present disclosure.

FIG. 4 is a diagram illustrating a process of dividing a sound signal into segments, according to some embodiments of the present disclosure.

FIG. 5 is a graph illustrating a general SI embedding vector.

FIG. 6 is a graph illustrating an SI embedding vector generated using a SER embedding vector, according to some embodiments of the present disclosure.

FIG. 7 is a flowchart illustrating a method of operating a sound recognition device, according to some embodiments of the present disclosure.

FIG. 8 is a flowchart illustrating a method of operating a sound recognition device, according to some embodiments of the present disclosure.

FIG. 9 is a diagram illustrating an electronic system, according to some embodiments of the present disclosure.

### DETAILED DESCRIPTION

Hereinafter, embodiments of the present disclosure will be described in detail and clearly to such an extent that an ordinary one in the art easily implements the present disclosure.

The terms “unit”, “module”, etc. to be used below and function blocks illustrated in drawings may be implemented in the form of a software component, a hardware component, or a combination thereof. Below, to describe the technical idea of the present disclosure clearly, additional descriptions of identical component vectors will be omitted to avoid redundancy.

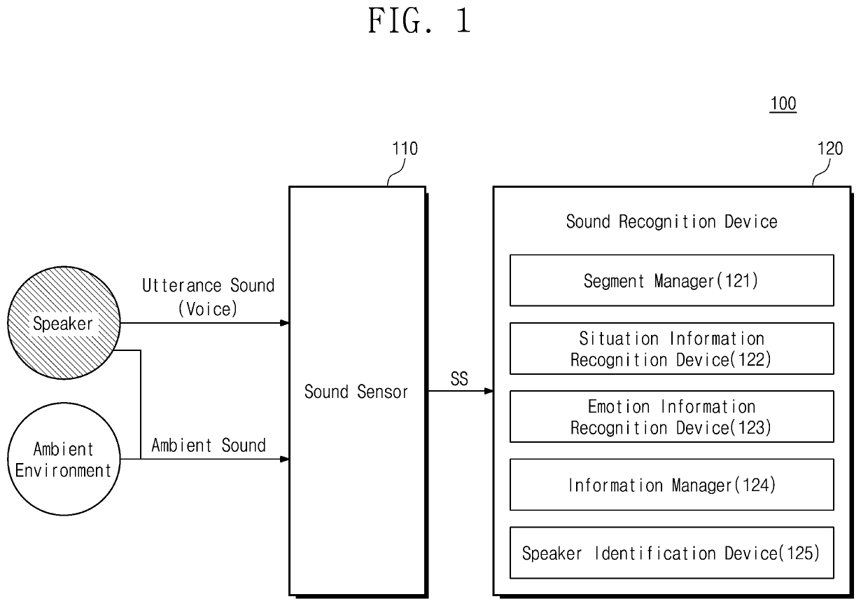

FIG. 1 is a block diagram illustrating an electronic device according to an embodiment of the present disclosure. Referring to FIG. 1, an electronic device 100 according to an embodiment of the present disclosure is illustrated. The electronic device 100 may be a device that provides various types of information to a user by analyzing a sound signal. For example, the electronic device 100 may be implemented as one of various electronic devices that process sound signals, such as a smart phone, a tablet personal computer (PC), a mobile phone, a desktop PC, a laptop computer, and a personal digital assistant (PDA).

The electronic device 100 may include a sound sensor 110 and a sound recognition device 120.

The sound sensor 110 may recognize sound and may generate a sound signal SS. The sound sensor 110 may generate the sound signal SS from an utterance sound and an ambient sound. The utterance sound may be a speaker's voice. The ambient sound may include a non-utterance sound of the speaker and an ambient environment sound. The speaker's non-utterance sound may include the speaker's laughter, applause, cry, whistle, etc.

In some embodiments, the utterance sound may include utterance sounds of a plurality of speakers. For example, the sound sensor 110 may recognize an utterance sound of a first speaker and an utterance sound of a second speaker.

The sound sensor 110 may provide the sound signal SS to the sound recognition device 120.

The sound recognition device 120 may receive the sound signal SS from the sound sensor 110. The sound recognition device 120 may generate emotion recognition information, situation recognition information, and speaker identification information based on the sound signal SS.

The emotion recognition information may indicate the speaker's recognized emotion. For example, the emotion recognition information may include a speaker's emotional label and a speaker's emotional state label. The emotion label may indicate one of a plurality of emotions such as joy, sadness, anger, and calmness. The emotional state label may indicate an arousal level and a valence level.

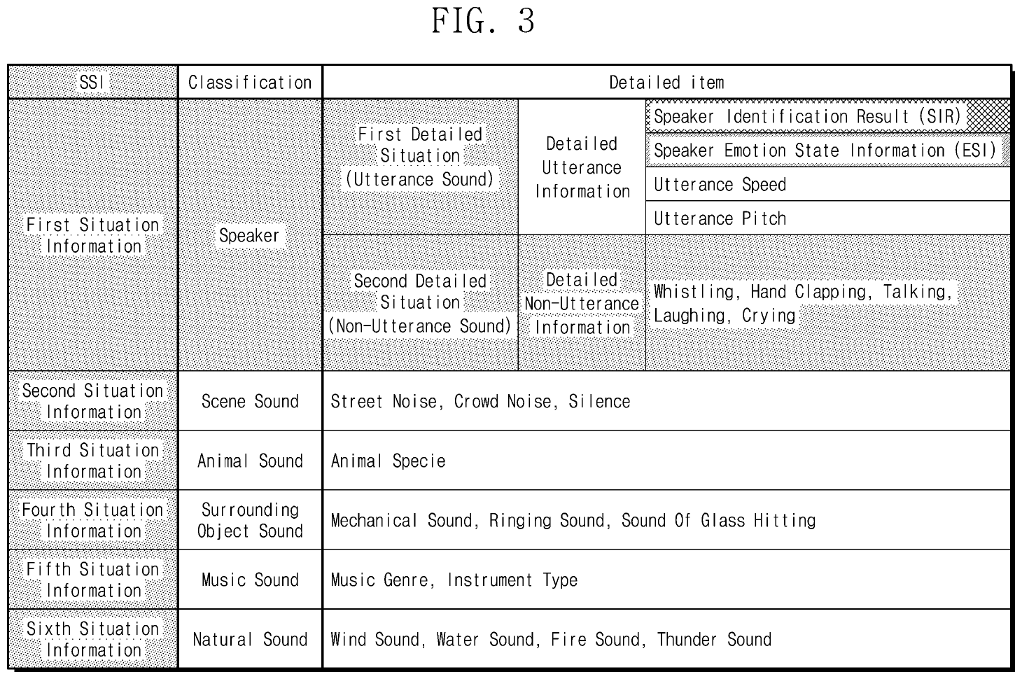

The situation recognition information may refer to a situation recognized by a speaker or an ambient environment. For example, the situation recognition information may include utterance situation information and ambient situation information. For example, the utterance situation information may include information about whether or not the speaker speaks, the utterance speed, etc. The ambient situation information may include information about a place where a speaker is located and surrounding objects. A more detailed description of the situation recognition information will be described later with reference to FIG. 3.

The speaker identification information may indicate a speaker who provides an utterance sound. For example, the speaker identification information may indicate whether the speaker matches a registered user. Alternatively, the speaker identification information may indicate a plurality of speakers by distinguishing them from each other.

The sound recognition device 120 may include a segment manager 121, a situation information recognition device 122, an emotion information recognition device 123, an information manager 124, and a speaker identification device 125.

The segment manager 121, the situation information recognition device 122, the emotion information recognition device 123, the information manager 124, and the speaker identification device 125 may be implemented as hardware, software, or a combination of hardware and software that performs a series of operations for generating emotion recognition information, situation recognition information, and speaker identification information from sound signals.

The segment manager 121 may receive the sound signal SS from the sound sensor 110. The segment manager 121 may divide the sound signal SS into a plurality of segments. Each of the plurality of segments may correspond to one situation. The segment manager 121 may determine whether each of the plurality of segments is a voice segment or a non-voice segment. The segment manager 121 may provide a plurality of segments to the situation information recognition device 122 and may provide voice segments to the emotion information recognition device 123 and the speaker identification device 125.

The situation information recognition device 122 may generate situation recognition information based on a plurality of segments.

The emotion information recognition device 123 may generate emotion recognition information based on the voice segment.

The information manager 124 may receive and store the situation recognition information, the emotion recognition information, and the speaker identification information, and may output them in response to a request.

The speaker identification device 125 fuses the voice segment and the emotion recognition information to generate the speaker identification information.

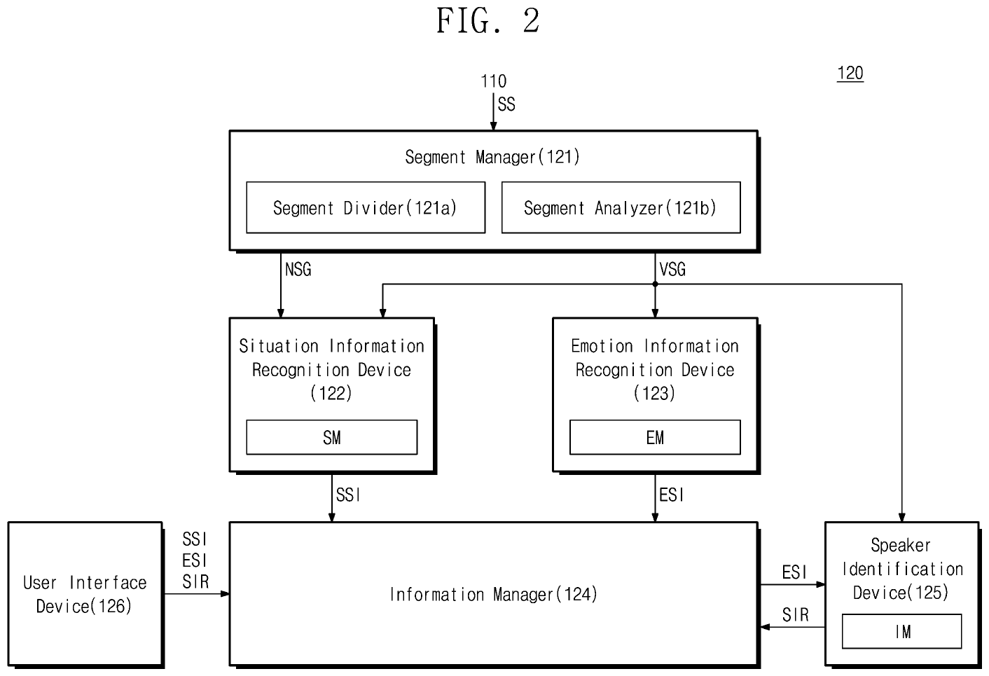

FIG. 2 is a block diagram embodying a sound recognition device of FIG. 1, according to some embodiments of the present disclosure. Referring to FIG. 2, the sound recognition device 120 is illustrated.

The segment manager 121 may include a segment divider 121a and a segment analyzer 121b.

The segment divider 121a may receive the sound signal SS. The segment divider 121a may divide the sound signal SS into a plurality of segments. The segment divider 121a may provide the plurality of segments to the segment analyzer 121b.

In some embodiments, the segment divider 121a may divide the sound signal SS into a plurality of frames of a reference time unit. Each of the plurality of frames may have the same interval of time.

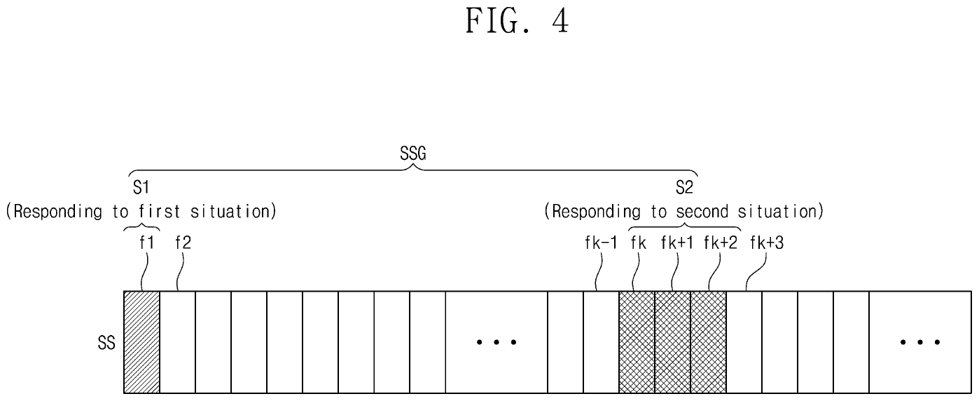

The segment divider 121a may generate situation information of each of a plurality of frames. The segment divider 121a may generate the plurality of segments by grouping a series of frames having the same situation information among the plurality of frames. A more detailed description associated with a process of generating the plurality of segments using the plurality of frames will be described later with reference to FIG. 4.

The segment analyzer 121b may receive the plurality of segments from the segment divider 121a. The segment analyzer 121b may determine whether each of the plurality of segments is a voice segment VSG or a non-voice segment NSG. The segment analyzer 121b may provide the voice segment VSG to the situation information recognition device 122, the emotion information recognition device 123, and the speaker identification device 125. The segment analyzer 121b may provide the voice segment VSG and the non-voice segment NSG to the situation information recognition device 122.

The situation information recognition device 122 may receive the voice segment VSG and the non-voice segment NSG from the segment analyzer 121b. The situation information recognition device 122 may generate situation recognition information SSI based on the voice segment VSG and the non-voice segment NSG. The situation information recognition device 122 may provide the situation recognition information SSI to the information manager 124.

In some embodiments, the situation information recognition device 122 may include a situation information recognition model SM. The situation information recognition model SM may be a model pre-trained through a large-scale sound data set, or may be a model implemented to operate based on predefined rules. The situation information recognition model SM may be a model that receives the voice segment VSG and the non-voice segment NSG and outputs the utterance situation information and the ambient situation information.

The emotion information recognition device 123 may receive the voice segment VSG from the segment analyzer 121b. The emotion information recognition device 123 may generate emotion recognition information ESI from the voice segment VSG. The emotion information recognition device 123 may provide the emotion recognition information ESI to the information manager 124.

The emotion information recognition device 123 may extract time domain features and frequency domain features of utterance sounds from the voice segment VSG. For example, the time domain features may include the loudness, speed, stress, pitch change, speech time, pause time, and the like of the utterance sound. In addition, the frequency domain features of the utterance sound may include a mel-frequency cepstral coefficient (MFCC) value of the utterance sound. The MFCC value may be a numerical value representing a unique feature of sound based on a frequency band that can be heard by humans.

In some embodiments, the emotion information recognition device 123 may include an emotion information recognition model EM. The emotion information recognition model EM may be a model trained in advance through a large-scale emotion-utterance data set, or may be a model implemented to operate based on predefined rules. The emotion information recognition model EM may receive time domain features and frequency domain features of the utterance sound and may output a speaker's emotional label and a speaker's emotional state label.

In some embodiments, the emotion information recognition device 123 may generate a SER (Speech Emotion Recognition) embedding vector. The SER embedding vector may include vectors indicating one of a plurality of emotion classes. The plurality of emotion classes may be obtained by classifying each of a plurality of emotions (joy, sadness, anger, etc.) and a plurality of emotional states (the arousal level and the valence level) into a plurality of classes through the emotion information recognition device 123. The emotion information recognition model EM may generate an emotion label and an emotion state label based on the SER embedding vector. Emotion recognition information EEI may include a SER vector.

The information manager 124 may receive the situation recognition information SSI from the situation information recognition device 122 and may receive the emotion recognition information ESI from the emotion information recognition device 123. The information manager 124 may provide the emotion recognition information ESI to the speaker identification device 125.

The speaker identification device 125 may receive the voice segment VSG from the segment analyzer 121b and may receive the emotion recognition information ESI from the information manager 124. The speaker identification device 125 may generate speaker identification information SIR by fusing the voice segment VSG and the emotion recognition information ESI.

The speaker identification device 125 may extract time domain features and frequency domain features of the utterance sound from the voice segment VSG.

According to some embodiments, the speaker identification device 125 may include a speaker identification model IM. The speaker identification model IM may be a model trained in advance through a large-scale speech data set, or may be a model implemented to operate based on predefined rules. The speaker identification model IM may output information comparing a speaker with a registered user or information for distinguishing a plurality of speakers based on time domain features, frequency domain features, and the emotion recognition information ESI of the utterance sounds.

According to some embodiments, the speaker identification model IM may generate a speaker identification (SI) embedding vector. The speaker identification model IM may have a plurality of speaker classes, and the SI embedding vector may include vectors indicating one of the plurality of speaker classes.

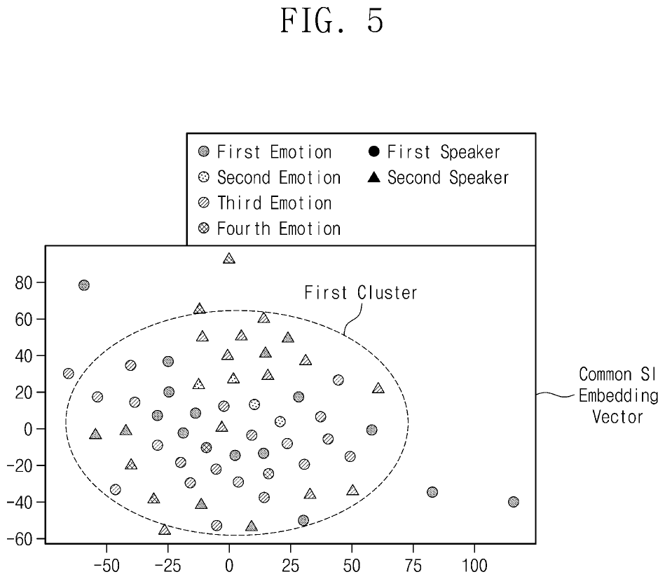

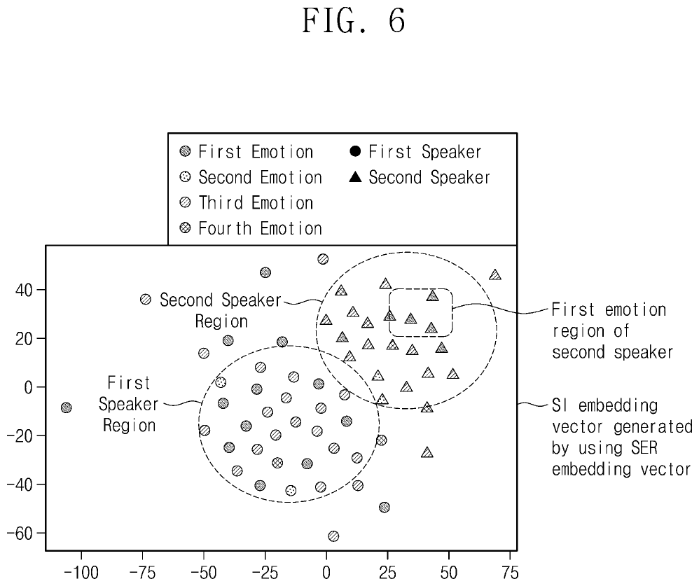

The speaker identification model IM may generate the SI embedding vector by additionally utilizing the SER embedding vector included in the emotion recognition information ESI. A more detailed description associated with the SI embedding vector generated using the SER embedding vector will be described later with reference to FIGS. 5 and 6.

The speaker identification device 125 may provide the speaker identification information SIR to the information manager 124.

The information manager 124 may receive the speaker identification information SIR from the speaker identification device 125. The information manager 124 may store the situation recognition information SSI, the emotion recognition information ESI, and speaker identification information SIR, and may output them in response to a request. For example, the information manager 124 may provide the situation recognition information SSI, the emotion recognition information ESI, and the speaker identification information SIR to a user interface device 126 depending on a user's request.

The user interface device 126 may visually provide the situation recognition information SSI, the emotion recognition information ESI, and speaker identification information SIR to the user. For example, the situation recognition information SSI, the emotion recognition information ESI, and the speaker identification information SIR may be displayed on a display of an electronic device such as a smart phone, a tablet PC, a desktop computer, and a PDA.

FIG. 3 is a table illustrating situation recognition information, emotion recognition information, and speaker identification information, according to some embodiments of the present disclosure. Referring to FIG. 3, the situation recognition information indicates one of first to sixth situations. The situation recognition information SSI, the emotion recognition information ESI, and the speaker identification information SIR of FIG. 3 may correspond to the situation recognition information SSI, the emotion recognition information ESI, and the speaker identification information SIR of FIG. 2, respectively.

First situation information may indicate a situation caused by a speaker. The first situation information may include a first detailed situation and a second detailed situation. The first detailed situation may indicate an utterance sound by a speaker. For example, the utterance sound may indicate a speaker's voice. The first detailed situation may include a speaker identification result SIR, speaker emotional state information ESI, an utterance speed, and an utterance pitch as detailed utterance information. The second detailed situation may indicate a non-utterance sound by a speaker. For example, the non-utterance sounds may refer to sounds that are caused by a speaker's motion but are not voices. For example, non-voice detail information may distinguish whistling, hand clapping, talking, laughing, crying, etc.

In some embodiments, the first detailed situation and the second detailed situation may be recognized as different situations. Segments recognized in different situations will be described later with reference to FIG. 4.

The second situation information may indicate a situation caused by scene sounds. The scene sounds may refer to sounds evoked throughout the speaker's surroundings. For example, the second situation information may distinguish between street noise, crowd noise, and silence.

The third situation information may indicate a situation caused by an animal sound. Animal sounds may refer to sounds caused by the cries of animals around the speaker. For example, the third situation information may distinguish animal species.

The fourth situation information may indicate a situation caused by the ambient object sound. The ambient object sound may refer to a sound caused by objects around the speaker. For example, the fourth situation information may distinguish a mechanical sound, a ringing sound, a sound of glass hitting, etc.

Fifth situation information may indicate a situation caused by music sounds. The music sounds may refer to singing sounds or musical instrument sounds around the speaker. For example, the fifth situation information may distinguish a music genre, a musical instrument type, etc.

The sixth situation information may indicate a situation caused by natural sounds. The natural sounds may refer to sounds caused by weather or a natural environment around the speaker. For example, the sixth situation information may distinguish wind, water, fire, and thunder.

FIG. 4 is a diagram illustrating a process of dividing a sound signal into segments, according to some embodiments of the present disclosure. Referring to FIG. 4, a sound segment SSG may be generated from the sound signal SS. The sound segment SSG includes one or more frames. The sound signal SS of FIG. 4 may correspond to the sound signals SS of FIGS. 1 and 2.

The sound signal SS may include the sound segment SSG. The sound segment SSG includes a first segment S1 and a second segment S2. The first segment S1 refers to a first situation, and the second segment S2 refers to a second situation. The sound segment SSG may be a single frame or a grouping of a series of frames having the same situation information. For example, the situation information may be one of the first to sixth situation information described with reference to FIG. 3. When the situation information corresponds to the first situation information, the first detailed situation and the second detailed situation may be recognized as different situations.

The sound signal SS may be divided into a plurality of frames of a reference time unit. The reference time unit may be a minimum reference time for distinguishing sound signals, and may be adjusted depending on a user's control. The sound signal SS may include a first frame f1, a second frame f2, and frames fk−1, fk, fk+1, fk+2, and fk+3.

For example, the first frame f1 may correspond to the first situation, and the second frame f2 may not correspond to the first situation. In this case, the first frame may be the first segment S1 corresponding to the first situation.

The k to k+2 frames fk, fk+1, and fk+2 correspond to the second situation, and the (k−1)-th frame fk−1 and the (k+3)-th frame fk+3 may not correspond to the second situation. In this case, a group of a series of k to k+2 frames fk, fk+1, and fk+2 may be the second segment S2 corresponding to the second situation. The second situation may be different from the first situation.

FIG. 5 is a graph illustrating a general SI embedding vector. Referring to FIG. 5, a common SI embedding vector is illustrated.

Each vector of the SI embedding vector graph may indicate one of first to fourth emotions of each of the first speaker and the second speaker. However, the scope of the present disclosure is not necessarily limited thereto.

For example, in the SI embedding vector graph, a circle may indicate a vector pointing to a first speaker, and a triangle may indicate a vector pointing to a second speaker. Each of the first to fourth emotions may be expressed in different colors. The first to second emotions are sequentially displayed in dark colors. For example, the first emotion may be expressed in the lightest color and the fourth emotion may be expressed in the deepest color.

In the SI embedding vector graph, the first cluster region may be a region including vectors whose distances from neighboring vectors are equal to or less than a specific distance. In the SI embedding vector graph of FIG. 5, vectors indicating the first and second speakers may be evenly distributed in the first cluster region.

FIG. 6 is a graph illustrating an SI embedding vector generated using a SER embedding vector, according to some embodiments of the present disclosure. Referring to FIG. 6, an SI embedding vector generated using a SER embedding vector is illustrated.

In the SI embedding vector graph generated using the SER embedding vector, a first speaker region and a second speaker region may be distinguished. Vectors classified as being included in the first speaker region may be vectors used by the speaker identification device to discriminate the first speaker. Vectors classified as being included in the second speaker region may be vectors used by the speaker identification device to discriminate the second speaker.

The second speaker region may include the first emotion region of the second speaker. The first emotion region of the second speaker may be a region including neighboring vectors whose distances to the first emotion vectors of the second speaker are equal to or less than a specific distance among a plurality of vectors indicating the first emotion of the second speaker. In the SI embedding vector graph of FIG. 6, only the first emotion region of the second speaker is indicated, but the present disclosure is not limited thereto.

Compared to the SI embedding vector graph generated without using the SER embedding vector, the SI embedding vector graph generated using the SER embedding vector clearly distinguishes and indicates the first speaker region and the second speaker region, thereby improving speaker discrimination.

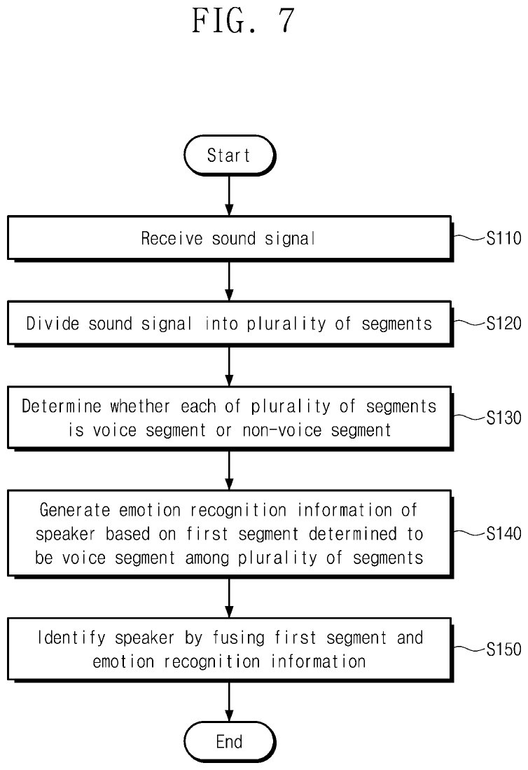

FIG. 7 is a flowchart illustrating a method of operating a sound recognition device, according to some embodiments of the present disclosure. Referring to FIG. 7, a method of operating the sound recognition device 120 will be described. The sound recognition device of FIG. 7 corresponds to the sound recognition device 120 of FIGS. 1 and 2.

In operation S110, the sound recognition device 120 may receive a sound signal from a sound sensor.

In operation S120, the sound recognition device 120 may divide the sound signal into a plurality of segments.

In some embodiments, operation S120 may include dividing the sound signal into a plurality of frames of a reference time unit, generating situation information of each of the plurality of frames, and generating a plurality of segments by grouping a series of frames having the same situation information among the plurality of frames.

In operation S130, the sound recognition device 120 may determine whether each of the plurality of segments is a voice segment or a non-voice segment.

In operation S140, the sound recognition device 120 may generate the emotion recognition information of the speaker based on the first segment determined to be the voice segment.

In some embodiments, operation S140 may include extracting time domain features and frequency domain features of the utterance sound corresponding to the first segment, inputting the time domain features and the frequency domain features of the utterance sound to an emotion information recognition model, and generating the emotion recognition information based on the speaker's emotion label and the speaker's emotion state label.

In operation S150, the sound recognition device 120 may identify the speaker by fusing the first segment and the emotion recognition information.

In some embodiments, operation S150 may include extracting time domain features and the frequency domain features of the utterance sound corresponding to the first segment, inputting the emotion recognition information together with the time domain features and the frequency domain features of the utterance sound into a speaker identification model, and generating the speaker identification information based on information comparing a speaker with a registered user and information identifying a plurality of speakers.

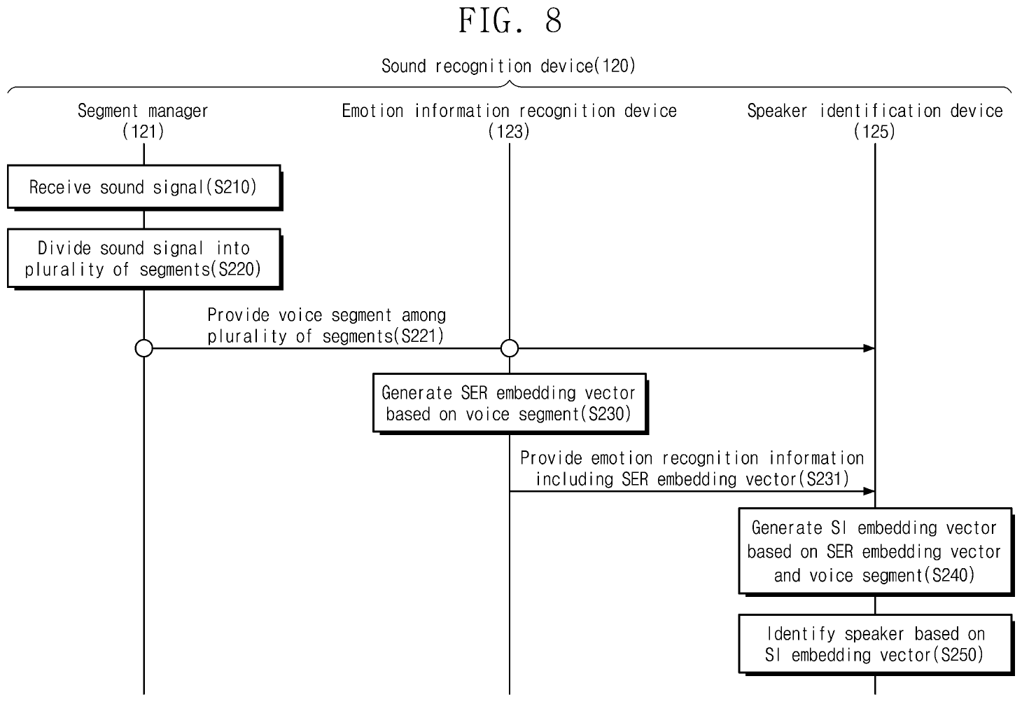

In operation S150, a more detailed description of identifying a speaker by fusing the first segment and the emotion recognition information will be described later with reference to FIG. 8.

FIG. 8 is a flowchart illustrating a method of operating a sound recognition device, according to some embodiments of the present disclosure. Referring to FIG. 8, a method of operating the sound recognition device 120 will be described.

The segment manager 121, the emotion information recognition device 123, and the speaker identification device 125 of FIG. 8 correspond to the segment manager 121, the emotion information recognition device 123, and the speaker identification device 125 of FIGS. 1 and 2, respectively.

In operation S210, the segment manager 121 may receive a sound signal from the sound sensor.

In operation S220, the segment manager 121 may divide the sound signal into a plurality of segments.

In some embodiments, operation S220 may include determining whether each of the plurality of segments is a voice segment or a non-voice segment by the segment manager 121.

In operation S221, the segment manager 121 may provide a voice segment among a plurality of segments to the emotion information recognition device 123.

In operation S230, the emotion information recognition device 123 may generate a SER embedding vector based on the voice segment.

In some embodiments, operation S230 may include dividing various emotions (joy, sadness, anger, etc.) and various emotional states (the arousal level and the valence level) into a plurality of emotion classes, generating vectors pointing to one of the plurality of emotion classes, and generating a SER vector based on the vectors pointing to one of the plurality of emotion classes, by the emotion information recognition device 123.

In operation S231, the emotion information recognition device 123 may provide the emotion recognition information including the SER embedding vector to the speaker identification device 125.

In operation S240, the speaker identification device 125 may generate the SI embedding vector based on the SER embedding vector and the voice segment.

In some embodiments, operation S240 may include generating time domain features and frequency domain features of the utterance sound from the voice segment, inputting the SER embedding vector together with the time domain features and the frequency domain features of the utterance sound into a speaker identification model, and generating the SI embedding vector based on the time domain features of the utterance sound, the frequency domain features of the utterance sound, and the SER embedding vector by the speaker identification model.

In operation S250, the speaker identification device 125 may identify a speaker based on the SI embedding vector.

In some embodiments, the speaker identification device 125 may provide the speaker identification information to the information manager 124.

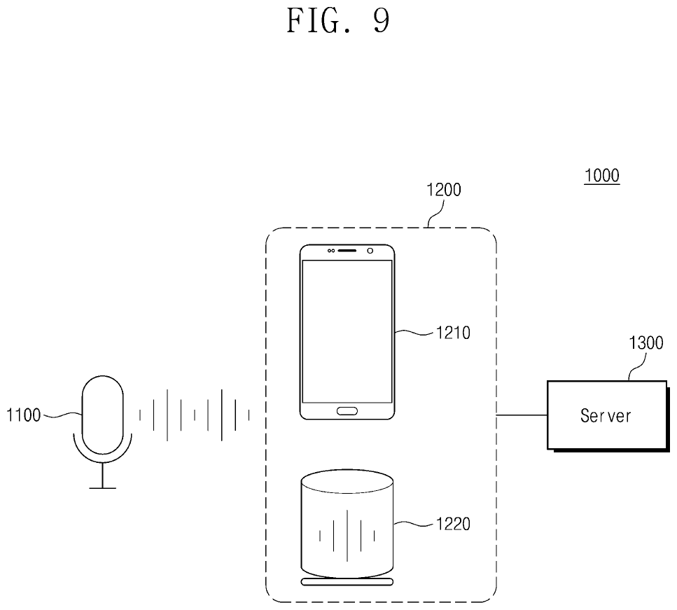

FIG. 9 is a diagram illustrating an electronic system, according to some embodiments of the present disclosure. Referring to FIG. 9, an electronic system 1000 is illustrated.

The electronic system 1000 may include a sound source 1100, an electronic device 1200, and a server 1300. The electronic device 1200 may correspond to the electronic device 100 of FIG. 1.

The sound source 1100 may generate sound. The sound may include at least one of an utterance sound and an ambient sound.

The electronic device 1200 may recognize sound from the sound source 1100 and may generate at least one of situation recognition information, emotion recognition information, and speaker identification information. The electronic device 1200 may provide the situation recognition information, the emotion recognition information, and the speaker identification information to the server 1300.

The electronic device 1200 may include a portable device 1210 or a peripheral device 1220. The portable device 1210 may be a smart phone, a PDA, etc. The portable device 1210 may receive a command from a user through a button interface and may start sound recognition in response to the command. The peripheral device 1220 may be an artificial intelligence speaker, etc. The peripheral device 1220 may recognize a user's voice command and may start sound recognition in response to the command.

The server 1300 may receive the situation recognition information, the emotion recognition information, and the speaker identification information from the electronic device 1200. The server 1300 may store the situation recognition information, the emotion recognition information, and the speaker identification information. The server 1300 may form a database for the situation recognition information, the emotion recognition information, and the speaker identification information, and may manage them.

According to an embodiment of the present disclosure, a method of operating a sound recognition device for identifying a speaker and an electronic device including the same are provided.

In addition, a method of operating a sound recognition device that analyzes a sound signal to generate emotion recognition information and situation recognition information, and accurately identifies a speaker by fusing a voice segment and the emotion recognition information, and an electronic device including the same are provided.

The above descriptions are specific embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A method of operating a sound recognition device communicating with a sound sensor configured to recognize an utterance sound of a first speaker to generate a sound signal, the method comprising:
receiving the sound signal from the sound sensor;
dividing the sound signal into a plurality of segments;
determining whether each of the plurality of segments is a voice segment or a non-voice segment;
generating first emotion recognition information of the first speaker based on a first segment determined to be the voice segment among the plurality of segments; and
identifying the first speaker by fusing the first segment and the first emotion recognition information.

2. The method of claim 1, wherein the sound sensor is further configured to further recognize an utterance sound of a second speaker different from the first speaker to generate the sound signal, and
wherein the method further comprising:
generating second emotion recognition information of the second speaker based on a second segment determined to be the voice segment among the plurality of segments; and
identifying the second speaker by fusing the second segment and the second emotion recognition information.

3. The method of claim 1, wherein the sound sensor is further configured to further recognize a non-utterance sound of the first speaker to generate the sound signal, and
wherein the method further comprising:
generating first situation recognition information based on a third segment determined to be the non-voice segment among the plurality of segments.

4. The method of claim 1, wherein the sound sensor is further configured to further recognize an ambient sound to generate the sound signal, and
wherein the method further comprising:
generating second situation recognition information based on a fourth segment determined to be the non-voice segment among the plurality of segments.

5. The method of claim 4, wherein the second situation recognition information indicates one of a scene sound, an animal sound, a surrounding object sound, a music sound, and a natural sound.

6. The method of claim 1, wherein the dividing of the sound signal into the plurality of segments includes:
dividing the sound signal into a plurality of frames of a reference time unit;
generating situation information of each of the plurality of frames; and
generating the plurality of segments by grouping a series of frames having the same situation information among the plurality of frames.

7. The method of claim 1, wherein the generating of the first emotion recognition information of the first speaker based on the first segment determined to be the voice segment among the plurality of segments includes:
generating a SER (Speech Emotion Recognition) embedding vector based on the first segment; and
generating the first emotion recognition information based on the SER embedding vector.

8. The method of claim 7, wherein the identifying of the first speaker by fusing the first segment and the first emotion recognition information includes:
generating a SI (Speaker Identification) embedding vector based on the first segment and the SER embedding vector; and
identifying the first speaker based on the SI embedding vector.

9. The method of claim 1, further comprising:
extracting a frequency domain feature and a time domain feature of the first segment, and
wherein the frequency domain feature includes an MFCC (Mel-frequency cepstral coefficient) value, and
wherein the time domain feature includes at least one of the loudness, speed, stress, pitch change, speech time, and pause time of the utterance sound.

10. An electronic device comprising:
a sound sensor configured to recognize an utterance sound of a first speaker to generate a sound signal; and
a sound recognition device configured to divide the sound signal into a plurality of segments, to determine whether each of the plurality of segments is a voice segment or a non-voice segment, to generate first emotion recognition information of the first speaker based on a first segment determined to be the voice segment, and to fuse the first segment and the first emotion recognition information to identify the first speaker.

11. The electronic device of claim 10, wherein the sound recognition device includes:
a segment manager configured to receive the sound signal, to divide the sound signal into a plurality of segments, and to determine whether each of the plurality of segments is a voice segment or a non-voice segment;
an emotion information recognition device configured to receive the first segment determined to be the voice segment, and to generate the first emotion recognition information of the first speaker based on the first segment; and
a speaker identification device configured to receive the first segment and the first emotion recognition information, and to fuse the first segment and the first emotion recognition information to identify the first speaker.

12. The electronic device of claim 11, wherein the sound sensor is further configured to further recognize an utterance sound of a second speaker different from the first speaker and a non-utterance sound of the first speaker to generate the sound signal,
wherein the emotion information recognition device is further configured to generate second emotion recognition information of the second speaker based on a second segment determined to be the voice segment; and
wherein the sound recognition device further includes a situation information recognition device configured to generate first situation recognition information based on a third segment determined to be the non-voice segment.

13. The electronic device of claim 11, wherein the sound sensor is further configured to further recognize an ambient sound to generate the sound signal, and
wherein the situation information recognition device is further configured to generate second situation recognition information based on a fourth segment determined to be the non-voice segment.

14. The electronic device of claim 11, wherein the emotion information recognition device is further configured to generate a SER (Speech Emotion Recognition) embedding vector based on the first segment, and generate the first emotion recognition information based on the SER embedding vector, and
wherein the speaker identification device is further configured to generate a SI (Speaker Identification) embedding vector based on the first segment and the SER embedding vector, and identify the first speaker based on the SI embedding vector.
